(19) United States
(12) Patent Application Publication
(10) Pub. No.: US 2026/0371108 A1
(43) Pub. Date: Nov. 19, 2026

(54) CELLULAR ENDPOINT DEVICE LOCALIZATION AND NETWORK PERFORMANCE INDICATOR FORECASTING

(71) Applicant: AT&T Intellectual Property I, L.P., Atlanta, GA (US)

(72) Inventors: Mehdi Malboubi, San Ramon, CA (US); Rennie Archibald, Seattle, WA (US); Jin Wang, Palo Alto, CA (US); Weihua Ye, Chicago, IL (US); Paul Maxwell, Alamo, CA (US); Xin Du, San Ramon, CA (US); WENJIE ZHAO, Princeton, NJ (US); Ernest Tsui, Danville, CA (US); Wenjing Hu, Basking Ridge, NJ (US)

(21) Appl. No.: 19/209,786

(22) Filed: May 15, 2025

(51) Int. Cl. H04W 24/02; H04W 24/08

(52) U.S. Cl. CPC H04W 24/02; H04W 24/08

(57) ABSTRACT

A processing system may obtain at least one network performance indicator measurement associated with an endpoint device in a cellular network, apply an input vector including the at least one network performance indicator measurement to a machine learning model implemented by the processing system that is configured to generate an output comprising a predicted location of the endpoint device, and tag the at least one network performance indicator measurement with the predicted location. The processing system may then reconfigure at least one aspect of the cellular network in response to the at least one network performance indicator measurement that is tagged with the predicted location.

The present disclosure relates generally to wireless communication networks, and more particularly to methods, non-transitory computer-readable media, and apparatuses for reconfiguring at least one aspect of a cellular network in response to at least one network performance indicator measurement that is tagged with a predicted location generated via a machine learning model in response to an input vector comprising the at least one network performance indicator measurement.

### BACKGROUND

A cloud radio access network (RAN) is part of the 3^{rd} Generation Partnership Project (3GPP) fifth generation (5G) specifications for mobile networks. As part of the migration of cellular networks towards 5G, a cloud RAN may be coupled to an Evolved Packet Core (EPC) network until new cellular core networks are deployed in accordance with 5G specifications. For instance, a cellular network in a “non-stand alone” (NSA) mode architecture may include 5G radio access network components supported by a fourth generation (4G)/Long Term Evolution (LTE) core network (e.g., an EPC network). However, in a 5G “standalone” (SA) mode point-to-point or service-based architecture, components and functions of the EPC network may be replaced by a 5G core network. Ultimately, 5G may deliver superior high speed and performance.

### SUMMARY

In one example, the present disclosure discloses a method, computer-readable medium, and apparatus for reconfiguring at least one aspect of a cellular network in response to at least one network performance indicator measurement that is tagged with a predicted location generated via a machine learning model in response to an input vector comprising the at least one network performance indicator measurement. For example, a processing system including at least one processor may obtain at least one network performance indicator measurement associated with an endpoint device in a cellular network, apply an input vector including the at least one network performance indicator measurement to a machine learning model implemented by the processing system that is configured to generate an output comprising a predicted location of the endpoint device, and tag the at least one network performance indicator measurement with the predicted location. The processing system may then reconfigure at least one aspect of the cellular network in response to the at least one network performance indicator measurement that is tagged with the predicted location.

### BRIEF DESCRIPTION OF THE DRAWINGS

The teachings of the present disclosure can be readily understood by considering the following detailed description in conjunction with the accompanying drawings, in which:

FIG. 1 illustrates a block diagram of an example system, in accordance with the present disclosure;

FIG. 2 illustrates an example architectural block diagram of a joint location estimation and network performance indicator prediction system of the present disclosure;

FIG. 3 illustrates an example of a system implementing a pair of machine learning models for joint endpoint device location prediction and network performance indicator value prediction in accordance with the present disclosure;

FIG. 4 illustrates additional example systems for MLM-based endpoint device location prediction in accordance with the present disclosure;

FIG. 5 illustrates still further example systems for MLM-based endpoint device location prediction in accordance with the present disclosure;

FIG. 6 illustrates a flowchart of an example method for reconfiguring at least one aspect of a cellular network in response to at least one network performance indicator measurement that is tagged with a predicted location generated via a machine learning model in response to an input vector comprising the at least one network performance indicator measurement; and

FIG. 7 illustrates an example of a computing device, or computing system, specifically programmed to perform the steps, functions, blocks, and/or operations described herein.

To facilitate understanding, similar reference numerals have been used, where possible, to designate elements that are common to the figures.

### DETAILED DESCRIPTION

The present disclosure broadly discloses methods, computer-readable media, and apparatuses for reconfiguring at least one aspect of a cellular network in response to at least one network performance indicator measurement that is tagged with a predicted location generated via a machine learning model in response to an input vector comprising the at least one network performance indicator measurement. In particular, examples of the present disclosure provide a reconfigurable machine learning (ML)-based framework with the ability to generate and incorporate auxiliary data for joint endpoint device localization and network performance indicator prediction in wireless networks, e.g., cellular networks. In one example, the present disclosure may include multiple machine learning models (MLMs) having a single or multi-layer architecture that is configured to determine the location of an endpoint device (e.g., latitude, longitude, and/or elevation, altitude, height, or the like). In one example, the MLM(s) may also be configured to determine the status of an endpoint device (e.g., indoor/outdoor, mobile/stationary, or the like). The MLMs of the present disclosure may determine endpoint device locations and predict network performance indicator values with high accuracy. MLMs of the present disclosure may also incorporate new/additional features in a scalable manner. Moreover, any number of MLMs can be instantiated and deployed for real-time prediction in a cellular network, such as MLMs for different cells/base stations, different clusters of cells, tracking areas, etc. In addition, MLMs of the present disclosure are also robust to changes in the cellular network and can provide location estimates for endpoint devices in new deployed cells.

In one example, the present disclosure may include smart-sampling and smart-encoding techniques to reduce the size of the MLM(s) and to facilitate the development of MLMs that can easily be instantiated in large-scale cellular networks with real-time location prediction and performance indicator prediction capabilities. In one example, aspects of the present disclosure may incorporate cellular standards (e.g., 3^{rd} Generation Partnership Project (3GPP), etc.) and may be instantiated as Open-Radio Access Network (ORAN)/radio access network (RAN) intelligent controller (RIC) components. In addition, insofar as location information is used for wireless/cellular network management and location-based services examples of the present disclosure can, inter alia, increase the accuracy and efficiency of such services and reduce energy consumption. For instance, real-time estimation of the location of an endpoint device may be used in different applications and operations in mobile networks, including network troubleshooting, network optimization and planning, and improving the quality of service (QoS)/quality of experience (QoE). The QoS/QoE improvements are particularly relevant for first responders, e.g., using a dedicated cellular network or network slice(s) for critical operations, such as FirstNet.

Developing MLMs for large-scale cellular networks that are accurate and have fast prediction rates over wide coverage areas may involve various factors. For instance, accuracy of such MLMs may rely upon the availability of network performance indicator measurements (e.g., key performance indicator (KPI) measurements) that have been labeled with detailed endpoint device location information (for example, latitude, longitude, and/or altitude) as training data. However, such training data may not be available for all cells, tracking areas, or other regions, which may limit the performance of a MLM for endpoint device localization in areas that the MLM has not been trained on. As such, the development of such MLM(s) may be dependent upon the ability to use large amount of training data and to incorporate numerous input features in a scalable manner in a large cellular network. In addition, success of such MLMs may further depend upon the complexity and size of the MLMs, and the network's capability to support concurrent instantiations of a large number of active, parallel MLMs. Furthermore, the reliability of such MLMs may be predicated upon the robustness and adaptability of the MLMs against noisy measurements and changes in the network/environment.

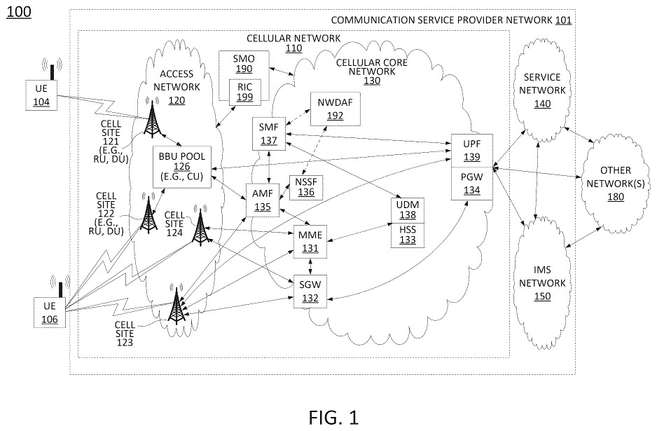

To further illustrate, other approaches may involve endpoint device localization in cellular networks based on trilateration/triangulation and using measurements from multiple known base stations (BS). These solutions encounter many challenges, including: (a) lack of having neighbor measurements for the majority of the records, (b) ambiguity in determining the correct neighbor cell (e.g., due to dynamic physical cell identifier (PCI) allocation, inaccurate/incomplete data, etc.), (c) noisy measurements resulting in no-solution or inaccurate/ambiguous solutions, and (d) high computational complexity for estimating billions of records in large-scale networks. In contrast, examples of the present disclosure provide a reconfigurable ML-based system with the ability to generate and incorporate auxiliary data for joint endpoint device localization and location-based network performance indicator prediction in cellular networks. This framework can identify complex patterns and create sophisticated mappings between multiple input features (e.g., network performance indicators or endpoint device location) and target features (e.g., endpoint device location or network performance indicators, respectively). Accordingly, the present ML-based system can provide services over a wider coverage area and provide higher accuracy, better scalability with use of numerous features, and faster prediction rate with more robustness and adaptability to changes in the network. These and other aspects of the present disclosure are discussed in greater detail below in connection with the examples of FIGS. 1-7.

To better understand the present disclosure, FIG. 1 illustrates an example network, or system 100 in which examples of the present disclosure may operate. In one example, the system 100 includes a communication service provider network 101. The communication service provider network 101 may comprise a cellular network 110 (e.g., a 4G/Long Term Evolution (LTE) network, a 4G/5G hybrid network, or the like), a service network 140, and an IP Multimedia Subsystem (IMS) network 150. The system 100 may further include other networks 180 connected to the communication service provider network 101.

In one example, the cellular network 110 comprises an access network 120 and a cellular core network 130. In one example, the access network 120 comprises a cloud RAN. For instance, a cloud RAN is part of the 3GPP 5G specifications for mobile networks. As part of the migration of cellular networks towards 5G, a cloud RAN may be coupled to an Evolved Packet Core (EPC) network until new cellular core networks are deployed in accordance with 5G specifications. In one example, access network 120 may include cell sites 121 and 122 and a baseband unit (BBU) pool 126. In a cloud RAN, radio frequency (RF) components, referred to as remote radio heads (RRHs), may be deployed remotely from baseband units, e.g., atop cell site masts, buildings, and so forth. In an Open RAN (O-RAN) architecture, these may alternatively or additionally be referred to as and/or may include radio units (RUs) (also referred to as O-RUs) and/or distributed units (DUs). In one example, the BBU pool 126 may be located at distances as far as 20-80 kilometers or more away from the antennas/remote radio heads of cell sites 121 and 122 that are serviced by the BBU pool 126. In an O-RAN architecture, these may alternatively or additionally be referred to as and/or may include centralized units (CUs). It should also be noted in accordance with efforts to migrate to 5G networks, cell sites may be deployed with new antenna and radio infrastructures such as multiple input multiple output (MIMO) antennas, and millimeter wave antennas. In this regard, a cell, e.g., the footprint or coverage area of a cell site may in some instances be smaller than the coverage provided by NodeBs or eNodeBs of 3G-4G RAN infrastructure. For example, the coverage of a cell site utilizing one or more millimeter wave antennas may be 1000 feet or less.

Although cloud RAN and or O-RAN infrastructure may include distributed units (DUs), radio units (RUs)/RRHs and centralized units (CU), e.g., baseband units (BBUs), a heterogeneous network may include cell sites where RRH and BBU components (or CUs, DUs, and RUs) remain co-located at the cell site. For instance, cell site 123 may include RRH and BBU components (or an RU, DU, and CU). Thus, cell site 123 may comprise a self-contained “base station.” With regard to cell sites 121 and 122, the “base stations” may comprise RRHs at cell sites 121 and 122 coupled with respective baseband units of BBU pool 126. In accordance with the present disclosure, any one or more of cell sites 121-124 may be deployed with antenna and radio infrastructures, including multiple input multiple output (MIMO) and millimeter wave antennas.

In one example, access network 120 may include both 4G/LTE and 5G radio access network infrastructure. For example, access network 120 may include cell site 124, which may comprise 4G/LTE base station equipment, e.g., an eNodeB. In addition, access network 120 may include cell sites comprising both 4G and 5G base station equipment, e.g., respective antennas, feed networks, baseband equipment, and so forth. For instance, cell site 123 may include both 4G and 5G base station equipment and corresponding connections to 4G and 5G components in cellular core network 130. Although access network 120 is illustrated as including both 4G and 5G components, in another example, 4G and 5G components may be considered to be contained within different access networks. Nevertheless, such different access networks may have a same wireless coverage area, or fully or partially overlapping coverage areas.

In one example, the cellular core network 130 provides various functions that support wireless services in the LTE environment. In one example, cellular core network 130 is an Internet Protocol (IP) packet core network that supports both real-time and non-real-time service delivery across a LTE network, e.g., as specified by the 3GPP standards. In one example, cell sites 121 and 122 in the access network 120 are in communication with the cellular core network 130 via baseband units in BBU pool 126.

In cellular core network 130, network devices such as Mobility Management Entity (MME) 131 and Serving Gateway (SGW) 132 support various functions as part of the cellular network 110. For example, MME 131 is the control node for LTE access network components, e.g., eNodeB aspects of cell sites 121-123. In one embodiment, MME 131 is responsible for UE (User Equipment) tracking and paging (e.g., such as retransmissions), bearer activation and deactivation process, selection of the SGW, and authentication of a user. In one embodiment, SGW 132 routes and forwards user data packets, while also acting as the mobility anchor for the user plane during inter-cell handovers and as an anchor for mobility between 5G, LTE and other wireless technologies, such as 2G and 3G wireless networks.

In addition, cellular core network 130 may comprise a Home Subscriber Server (HSS) 133 that contains subscription-related information (e.g., subscriber profiles), performs authentication and authorization of a wireless service user, and provides information about the subscriber's location. The cellular core network 130 may also comprise a packet data network (PDN) gateway (PGW) 134 which serves as a gateway that provides access between the cellular core network 130 and various packet data networks (PDNs), e.g., service network 140, IMS network 150, other network(s) 180, and the like.

The foregoing describes long term evolution (LTE) cellular core network components (e.g., EPC components). In accordance with the present disclosure, cellular core network 130 may further include other types of wireless network components e.g., 2G network components, 3G network components, 5G network components, etc. Thus, cellular core network 130 may comprise an integrated network, e.g., including any two or more of 2G-5G infrastructures and technologies, and the like. For example, as illustrated in FIG. 1, cellular core network 130 further comprises 5G components, including: an access and mobility management function (AMF) 135, a network slice selection function (NSSF) 136, a session management function (SMF), a unified data management function (UDM) 138, a user plane function (UPF) 139, and a network data analytics function (NWDAF) 192.

In one example, AMF 135 may perform registration management, connection management, endpoint device reachability management, mobility management, access authentication and authorization, security anchoring, security context management, coordination with non-5G components, e.g., MME 131, and so forth. NSSF 136 may select a network slice or network slices to serve an endpoint device, or may indicate one or more network slices that are permitted to be selected to serve an endpoint device. For instance, in one example, AMF 135 may query NSSF 136 for one or more network slices in response to a request from an endpoint device (such as UE 104 or UE 106) to establish a session to communicate with a PDN. The NSSF 136 may provide the selection to AMF 135, or may provide one or more permitted network slices to AMF 135, where AMF 135 may select the network slice from among the choices. A network slice may comprise a set of cellular network components, e.g., network functions (NFs), such as AMF(s), SMF(s), UPF(s), and so forth that may be arranged into different network slices which may logically be considered to be separate cellular networks. A specific set of NFs arranged into a network slice may also be referred to as a network slice instance (NSI). In one example, different network slices may be preferentially utilized for different types of services. For instance, a first network slice may be utilized for sensor data communications, Internet of Things (IoT), and machine-type communication (MTC), a second network slice may be used for streaming video services, a third network slice may be utilized for voice calling, a fourth network slice may be used for gaming services, a fifth network slice may be used for first responder or other governmental services, and so forth.

In one example, SMF 137 may perform endpoint device IP address management, UPF selection, UPF configuration for endpoint device traffic routing to an external packet data network (PDN), charging data collection, quality of service (QoS) enforcement, and so forth. In one example, UDM 138 may perform user identification, credential processing, access authorization, registration management, mobility management, subscription management, and so forth. As illustrated in FIG. 1, UDM 138 may be tightly coupled to HSS 133. For instance, UDM 138 and HSS 133 may be co-located on a single host device, or may share a same processing system comprising one or more host devices. In one example, UDM 138 and HSS 133 may comprise interfaces for accessing the same or substantially similar information stored in a database on a same shared device or one or more different devices, such as subscription information, endpoint device capability information, endpoint device location information, and so forth. For instance, in one example, UDM 138 and HSS 133 may both access subscription information or the like that is stored in a unified data repository (UDR) (not shown).

UPF 139 may provide an interconnection point to one or more external packet data networks (PDN(s)) and perform packet routing and forwarding, QoS enforcement, traffic shaping, packet inspection, and so forth. In one example, UPF 139 may also comprise a mobility anchor point for 4G-to-5G and 5G-to-4G session transfers. In this regard, it should be noted that UPF 139 and PGW 134 may provide the same or substantially similar functions, and in one example, may comprise the same device, or may share a same processing system comprising one or more host devices.

As noted above, cellular core network 130 further includes NWDAF 192, which may be tasked monitoring various network functions, network slices, and access network components. In one example, NWDAF 192 may subscribe to data analytics (e.g., performance indicators/KPIs) from a variety of NFs, may store these analytics, and may provide such analytics to other NFs that may request such data. In one example, NSSF 136 may obtain slice load level analytics which may be used by NSSF 136 to select a network slice or network slices to serve an endpoint device, or may indicate one or more network slices that are permitted to be selected to serve an endpoint device. For instance, AMF 135 may query NSSF 136 for one or more network slices in response to a request from an endpoint device to establish a session to communicate with a PDN (e.g., which may be represented by other network(s) 180 in FIG. 1). The NSSF 136 may provide the selection to AMF 135, or may provide one or more permitted network slices to AMF 135, where AMF 135 may select the network slice from among the choices. In one example, AMF 135 may utilize additional information such as a UE/subscriber class or category from HSS 133. For example, when a slice is indicated to have a particular load level above a threshold, UEs/subscribers of one or more defined classes/categories may be prevented from accessing the slice, or may have preferential access to the slice over other classes/categories, and so forth. In accordance with the present disclosure, in one example NWDAF 192 may track various performance indicators with respect to access network 120 and/or regarding particular components thereof (such as RUs, DUs, CU, etc., e.g., cell sites 121 and 122, BBU pool 125, cell sites 123 and 124, and so forth).

It should be noted that other examples may comprise a cellular network with a “non-stand alone” (NSA) mode architecture where 5G radio access network components, such as a “new radio” (NR), “gNodeB” (or “gNB”), and so forth are supported by a 4G/LTE core network (e.g., an EPC network), or a 5G “standalone” (SA) mode point-to-point or service-based architecture where components and functions of an EPC network are replaced by a 5G core network (e.g., an “NC”). For instance, in non-standalone (NSA) mode architecture, LTE radio equipment may continue to be used for cell signaling and management communications, while user data may rely upon a 5G new radio (NR), including millimeter wave communications, for example. However, examples of the present disclosure relate to a hybrid, or integrated 4G/LTE-5G cellular core network such as cellular core network 130 illustrated in FIG. 1. In this regard, FIG. 1 illustrates a connection between AMF 135 and MME 131, e.g., an “N26” interface which may convey signaling between AMF 135 and MME 131 relating to endpoint device tracking as endpoint devices are served via 4G or 5G components, respectively, signaling relating to handovers between 4G and 5G components, and so forth.

In one example, service network 140 may comprise one or more devices for providing services to subscribers, customers, and or users. For example, communication service provider network 101 may provide a cloud storage service, web server hosting, and other services. As such, service network 140 may represent aspects of communication service provider network 101 where infrastructure for supporting such services may be deployed. In one example, other networks 180 may represent one or more enterprise networks, a circuit switched network (e.g., a public switched telephone network (PSTN)), a cable network, a digital subscriber line (DSL) network, a metropolitan area network (MAN), an Internet service provider (ISP) network, and the like. In one example, the other networks 180 may include different types of networks. In another example, the other networks 180 may be the same type of network. In one example, the other networks 180 may represent the Internet in general. In this regard, it should be noted that any one or more of service network 140, other networks 180, or IMS network 150 may comprise a packet data network (PDN) to which an endpoint device may establish a connection via cellular core network 130 in accordance with the present disclosure.

FIG. 1 also illustrates various endpoint devices, e.g., user equipment (UE) 104 and 106. UE 104 and 106 may each comprise a cellular telephone, a smartphone, a tablet computing device, a laptop computer, a pair of computing glasses, a wireless enabled wristwatch, a wireless transceiver for a fixed wireless broadband (FWB) deployment, or any other cellular-capable mobile telephony and computing device (broadly, “an endpoint device”). In one example, each of UE 104 and UE 106 may each be equipped with one or more directional antennas, or antenna arrays (e.g., having a half-power azimuthal beamwidth of 120 degrees or less, 90 degrees or less, 60 degrees or less, etc.), e.g., MIMO antenna(s) to receive multi-path and/or spatial diversity signals. Each of UE 104 and UE 106 may also include a gyroscope and compass to determine orientation(s), a global positioning system (GPS) receiver for determining a location, and so forth. As illustrated in FIG. 1, UE 104 may access wireless services via the cell site 121, while UE 106 may access wireless services via any of cell sites 122-124 located in the access network 120.

In one example, any one or more of the components of cellular core network 130 may comprise network function virtualization infrastructure (NFVI), e.g., SDN host devices (i.e., physical devices) configured to operate as various virtual network functions (VNFs), such as a virtual MME (vMME), a virtual HHS (vHSS), a virtual serving gateway (vSGW), a virtual packet data network gateway (vPGW), and so forth. For instance, MME 131 may comprise a vMME, SGW 132 may comprise a vSGW, and so forth. Similarly, AMF 135, NSSF 136, SMF 137, UDM 138, NWDAF 192, and/or UPF 139 may also comprise NFVI configured to operate as VNFs. In addition, when comprised of various NFVI, the cellular core network 130 may be expanded (or contracted) to include more or less components than the state of cellular core network 130 that is illustrated in FIG. 1.

In this regard, the cellular network 110 may also include a service and management orchestrator (SMO) 190. For instance, in one example, SMO 190 may comprise a self-optimizing network (SON) orchestrator and/or software defined network (SDN) controller. To illustrate, SMO 190 may function as a self-optimizing network (SON) orchestrator that is responsible for activating and deactivating, allocating and deallocating, and otherwise managing a variety of network components. For instance, SMO 190 may activate and deactivate antennas/remote radio heads of cell sites 121 and 122, respectively, may allocate and deactivate baseband units in BBU pool 126, and may perform other operations for reconfiguring at least one aspect of a cellular network in response to at least one network performance indicator measurement that is tagged with a predicted location generated via a machine learning model in response to an input vector comprising the at least one network performance indicator measurement, in accordance with the present disclosure.

In one example, SMO 190 may further comprise a SDN controller that is responsible for instantiating, configuring, managing, and releasing VNFs. For example, in a SDN architecture, a SDN controller may instantiate VNFs on shared hardware, e.g., NFVI/host devices/SDN nodes, which may be physically located in various places. In one example, the configuring, releasing, and reconfiguring of SDN nodes is controlled by the SDN controller, which may store configuration codes, e.g., computer/processor-executable programs, instructions, or the like for various functions which can be loaded onto an SDN node. In another example, the SDN controller may instruct, or request an SDN node to retrieve appropriate configuration codes from a network-based repository, e.g., a storage device, to relieve the SDN controller from having to store and transfer configuration codes for various functions to the SDN nodes.

Accordingly, the SMO 190 may be connected directly or indirectly to any one or more network elements of cellular core network 130, access network 120, and of the system 100 in general. Due to the relatively large number of connections available between SMO 190 and other network elements, none of the actual links to the SMO 190 are shown in FIG. 1. Similarly, intermediate devices and links between MME 131, SGW 132, cell sites 121-124, PGW 134, AMF 135, NSSF 136, SMF 137, UDM 138, NWDAF 192, and/or UPF 139, and other components of system 100 are also omitted for clarity, such as additional routers, switches, gateways, and the like.

In one example, SMO 190 may include a RAN intelligent controller (RAN-IC or RIC) 199. For instance, in an O-RAN architecture, the RIC 199 may be deployed for managing and controlling various RAN components/functions, e.g., CUs, DUs, and RUs. For instance, RIC 199 may comprise a platform that hosts various RAN applications (e.g., xApps/rApps) that may be used to configure and reconfigure various components of access network 120. In one example, aspects of RIC 199 may represent functionality of an SON orchestrator, or vice versa. In one example, RIC 199 and/or SMO 190 may request and/or subscribe to various information that may be obtained and stored by NWDAF 192. Such information may include time-stamped RAN performance indicators (e.g., KPIs for various time blocks/intervals), RAN environment state information (e.g., RAN parameters and/or settings associated with the time blocks/intervals for which performance indicators may be measured/collected), or the like. Alternatively, or in addition RIC 199 and/or SMO 190 may obtain various information from RAN components or other network elements directly (e.g., without NWDAF 192 as an intermediary). In one example, SMO 190 may comprise a computing platform/system hosting various RAN applications, which may comprise programs, code, etc. running on computing hardware of the SMO 190. As noted above, in one example, the RAN applications may include xApps and rApps.

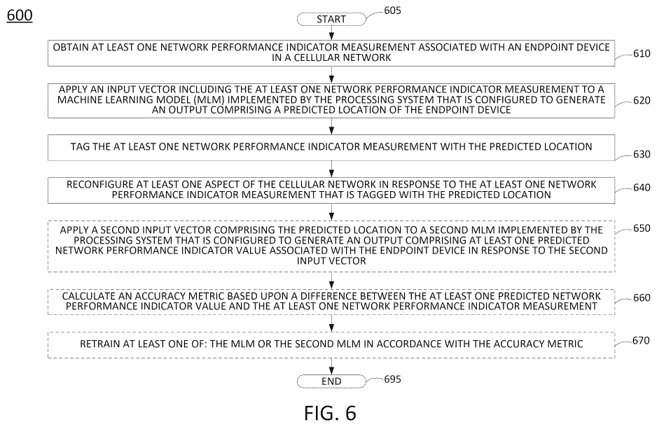

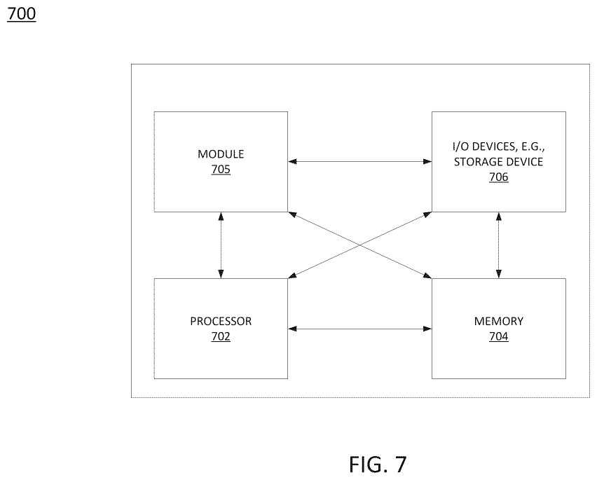

In one example, aspects of the present disclosure for reconfiguring at least one aspect of a cellular network in response to at least one network performance indicator measurement that is tagged with a predicted location generated via a machine learning model in response to an input vector comprising the at least one network performance indicator measurement, e.g., as described in greater detail below in connection with the example method 600 of FIG. 6, may be performed by RIC 199 and/or SMO 190. In this regard, in one example, RIC 199 and/or SMO 190 may comprise all or a portion of a computing device or system, such as computing system 700, and/or processing system 702 as described in connection with FIG. 7 below, and may be configured to perform various operations in connection with examples of the present disclosure for reconfiguring at least one aspect of a cellular network in response to at least one network performance indicator measurement that is tagged with a predicted location generated via a machine learning model in response to an input vector comprising the at least one network performance indicator measurement. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device including one or more processors, or cores (e.g., as illustrated in FIG. 7 and discussed below) or multiple computing devices collectively configured to perform various steps, functions, and/or operations in accordance with the present disclosure.

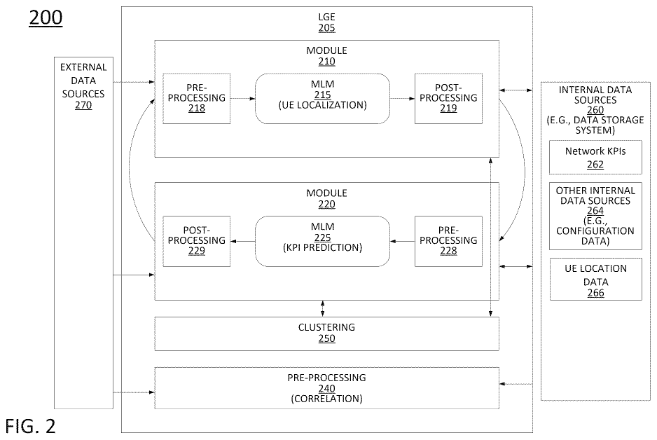

To further illustrate, in some cases, NWDAF 192 may collect and store time-stamped location information for various endpoint devices. As such, the time-stamped location information may be correlated with one or more time-stamped network performance indicators associated with respective endpoint devices. Alternatively, or in addition, at least some of the RAN performance indicators may also be location-stamped. For instance, some endpoint devices may be configured to report detailed location information to the cellular network 110, e.g., where the location information may be measured by an endpoint device using a GPS unit, or the like. For example, some endpoint devices may report location information in connection with network performance indicator measurements provided in minimization of drive tests (MDT) reports. However, it should be noted that a substantial percentage of endpoint devices may omit reporting of detailed location information, e.g., with MDT reports or other reporting of network performance indicator measurements. In this regard, examples of the present disclosure may include one or more machine learning models (MLMs) trained/configured to predict endpoint device locations based upon network performance indicator data/measurements. For instance, in one example, network performance indicator measurements that are tagged with location information may be used as training data to train such MLM(s), where the MLM(s), once trained, may be used to predict locations of endpoint devices that do not provide detailed location information based on one or more reported network performance indicator measurements. In one example, such MLM(s) may be deployed in, e.g., implemented by, the SMO 190 and/or RIC 199. Alternatively, or in addition, such MLM(s) may be implemented by/instantiated at NWDAF 192. In still another example, such MLM(s) may operate in a cloud computing system, such as a public cloud. Additional functionality and operations of SMO 190, RIC 199, and/or NWDAF 192 may be described in greater detail below in connection with the example method 600 of FIG. 6 and/or as described in connection with any one or more of the examples of FIGS. 2-5.

The foregoing description of the system 100 is provided as an illustrative example only. In other words, the example of system 100 is merely illustrative of one network configuration that is suitable for implementing embodiments of the present disclosure. As such, other logical and/or physical arrangements for the system 100 may be implemented in accordance with the present disclosure. For example, the system 100 may be expanded to include additional networks, such as network operations center (NOC) networks, additional access networks, and so forth. The system 100 may also be expanded to include additional network elements such as border elements, routers, switches, policy servers, security devices, gateways, a content distribution network (CDN) and the like, without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements.

For instance, in one example, the cellular core network 130 may further include a Diameter routing agent (DRA) which may be engaged in the proper routing of messages between other elements within cellular core network 130, and with other components of the system 100, such as a call session control function (CSCF) (not shown) in IMS network 150. In another example, the NSSF 136 may be integrated within the AMF 135. In addition, cellular core network 130 may also include additional 5G NG core components, such as: a policy control function (PCF), an authentication server function (AUSF), a network repository function (NRF), and other application functions (AFs).

In one example, any one or more of cell sites 121-124 may comprise 2G, 3G, 4G and/or LTE radios, e.g., in addition to 5G new radio (NR), or gNB functionality. For instance, cell site 123 is illustrated as being in communication with AMF 135 in addition to MME 131 and SGW 132. It should be noted that the example described above involves a 4G-to-5G PDN connection transfer (and 5G-to-4G reversion) that includes UE 106 transferring from cell site 124 to cell site 122 (and vice versa). However, in another example, UE 106 may establish a 4G session to a PDN via 4G/LTE components of cell site 123, and may be transferred to a 5G connection via 5G components of the same cell site 123 in response to one or more trigger conditions as described above.

In addition, network elements or functions that are illustrated as being deployed in one portion of the communication service provider network 101 may alternatively or additionally be deployed in another portion of the communication service provider network 101. For example, SMO 190 may be deployed in cellular core network 130, within access network 120, or may comprise a distributed computing platform having hardware components within cellular core network 130 and access network 120. Thus, these and other modifications are all contemplated within the scope of the present disclosure.

To further aid in understanding the present disclosure, FIG. 2 illustrates an example architectural block diagram of a joint location estimation and network performance indicator prediction system of the present disclosure. In one example, such a system may be referred to as an intelligent, reconfigurable and generative user localization (IRG-UL) platform. As illustrated in FIG. 2 the IRG-UL platform 200 may include a localization and performance indicator generation engine (LGE) 205, which may be comprised of two main modules: module 210 including a user localization MLM 215, and module 220 including a MLM 225 for location-based network performance indicator prediction. In particular, MLM 215 of module 210 may use network performance indicator measurements (e.g., network KPIs 262) as an input/input vector to estimate/predict endpoint device/UE location, e.g., as an output of the MLM 215. Module 220, on the other hand, may use the endpoint device location (e.g., UE location data 266) as an input/input vector to MLM 225 to estimate/predict one or more network performance indicator values. For instance, in one example, module 210 may use one or more network performance indicator measurements (such as cell identifier (ID), timing advance (TA), reference signal received power (RSRP), reference signal received quality (RSRQ), network and UE resource utilization performance indicators, signal quality metrics in both up-link and down-link directions, signal strength metrics in both uplink and down-link directions, etc.) from internal data sources 260 as an input vector to the MLM 215, and may provide a predicted endpoint device location (e.g., latitude and longitude (or latitude, longitude, and altitude), etc.) as an output of the MLM 215. In one example, this output may be stored as an additional/new record of UE location data 266. For instance, internal data sources 260 may represent a network repository, such as a NWDAF, UDM, or the like, for storing network KPIs 262, other internal data 264 (such as cell configuration data), and endpoint device/UE location data 266. On the other hand, module 220 may use an input vector of endpoint device location, e.g., latitude and longitude, or the like (and in some examples including other factors, such as cell-ID, TA, etc.) as an input vector to the MLM 225 and may provide one or more predicted network performance indicator values (e.g., RSRP and/or RSRQ, etc.) as the output of the MLM 225. In one example, such predicted network performance indicator value(s) may be stored as new/additional records of the network KPIs 262. In one example, the MLMs 215 and 225 can be implemented using transform learning techniques where pre-trained models can be initially loaded and then fine-tuned using domain-specific data (e.g., proprietary data).

These two modules/MLM are complimentary to each-other, and in one example can be jointly trained, e.g., in a reinforcing, transformative, collaborative, and/or alternative manner. For instance, the two modules/MLMs may be jointly trained to optimize a cost-function, e.g., where one module/MLM can recursively provide at least a portion of the input data for the other module/MLM. In various examples, different optimization techniques can be used, including linear, non-linear, convex, and/or heuristic optimization methods. In one example, to increase the adaptability of the IRG-UL platform 200/LGE 205 to changes in the network and to provide useful predictions for new deployed cells, modules 210 and 220 can be instantiated by the initial deployment of MLMs 215 and 225 pre-trained with data from other cells, where fine-tuning may be applied to the modules/MLMs once deployed for use in connection with a new cell in a transformative learning manner.

In one example, one or more pre-processing and/or post-processing techniques (e.g., 218, 219, 228, 229) can be applied in each of modules 210 and 220, respectively, to, for example: scale data, convert categorical data to numeric data (e.g., using one-hot encoding, label encoding, or the like), filter out noisy data and/or outliers, and so forth. In some cases, more complex data transformation, such as principal component analysis (PCA), may be used for dimension reduction and filtering noise. Alternatively, or in addition, kernel methods can be used to increase the dimensionality of the data and transform non-linearly separable data into linearly separable data.

In one example, to develop the MLMs 215 and 225, data from different internal and external sources may be used. In one example, these data/records may be correlated and jointly processed with endpoint device location information from a variety of internal/external sources (e.g., MDT data records or the like). For instance, examples of internal data sources 260 are network performance indicator measurements/records (e.g., network KPIs 262), UE location records 266 (e.g., from at least some endpoint devices/UE that reported detailed location information and/or which may have been previously predicted via MLM 215), other internal data sources 264 (e.g., cell configuration parameters, such as transmit power, boresight direction, tilt, modulation coding scheme (MCS), endpoint device charging data records, etc.), and so forth. Examples of external data sources 270 are geographic maps, weather information, demographic information, and/or social networks information. In one example, such data can be used to improve the accuracy of the location estimates of MLM 215 (e.g., by correlating with social network posts) and/or can be used to improve the accuracy of network performance indicator value prediction via MLM 225 (e.g., by incorporating map data or weather information as additional input(s) to MLM 225).

In general, the MLMs 215 and 225 can be trained/built using different public and/or proprietary packages, languages, platforms, and/or environments. Also, these MLMs 215 and 225 can be developed in a way that MLMs 215 and 225 can be shared between different platforms and applications. For example, in one implementation, a MLM may be trained in Python and saved in a Predictive Model Markup Language (PMML) format, where the PMML models may then be loaded into Java for deployment in production network to provide real-time prediction capability.

To facilitate the development of MLMs 215 and 225, and to improve performance of IRG-UL platform 200/LGE 205, input data may be clustered, where the MLMs 215 and 225 can be particularized to a given cluster. For instance, data clustering (e.g., data clustering module 250) can be accomplished using different clustering techniques or based on different criteria. For instance, in one example, cell-configuration parameters may be used as clustering criteria, where cells having the same or similar cell configuration parameters (e.g., quantified by having differences less than a threshold amount or percentage with respect to one or more configuration setting values) may be clustered, and where respective MLMs 215 and 225 may be trained/configured for cells assigned to/associated with a given cluster. Without loss of generality, possible cell configuration parameters include: technology (e.g., LTE, 5G, or the like), frequency band, operating frequency, antenna tilt, antenna azimuth, and/or boresight direction, transmit power, number of antennas, cell latitude, cell longitude, antenna propagation model/type, clutter type, environment type, and part of the digits of eNB-ID or gNB-ID, and so forth. In one example, MLM pairs, such as MLMs 215 and 225, and/or LGEs, such as LGE 205, can be instantiated at the network edge to reduce the latency of prediction to enhance real-time or near-real-time applications (e.g., rApps, or the like). It should be noted that in one example, the type(s) and input feature(s) of the MLMs for each cluster may be different.

In various examples, pre/post processing (e.g., 218, 219, 228, and 229) can be applied at different stages. Examples of pre-and post-processing may include: scaling data, converting categorical data to numeric data (e.g., using one-hot encoding, label encoding, or the like), filtering noisy data and outliers, encrypting and anonymizing data and sensitive information (e.g., UE Identity, international mobile subscriber identity (IMSI), international mobile equipment identity (IMEI), etc.), and so forth. Pre-/post-processing may alternatively or additionally include converting data from one domain to another domain. For example, by pre-processing, a latitude and longitude location of a UE can be transformed to a polar system by computing the distance of the UE from a serving cell and a bearing angle of the UE from the serving cell. In addition, with post-processing, the inverse of this operation can be applied.

In one example, the modules of LGE 205 may be reconfigured, e.g., periodically or otherwise. For example, the type(s) of the MLMs 215 and 225 and their hyper-parameters can be optimized, tuned, and/or reconfigured adaptively and recursively. In one example, the IRG-UL platform 200 can control how the processed data is stored or visualized, e.g., for a user and/or client system, such a SMO, a RIC, and/or other ORAN xApps or rApps instantiated/deployed anywhere within a cellular network. In one example, a user interface and/or application programming interface (API) can directly process/apply requests from a user or other automated systems, applications, or the like. In another example, a generative artificial intelligence (AI)/ML agent may be included, and which may convert/transform user intents to respective commands, control messages, queries, or the like. In one example, a client (e.g., an internal or external user, agent, or application) may access the IRG-UL platform 200 via an authentication, authorization, and accounting (AAA) module. The internal data sources 260 (e.g., a data storage system) may store data in appropriate databases (e.g., relation databases, graph databases (e.g., neo4J, etc.), time-series databases (e.g., InfluxDB, etc.), and so forth). In one example, different technologies may be used to visualize the processed data for the client. In addition, internal and external clients can also use a variety of methods to obtain access to the framework and its data, for example via APIs, interfaces and gateways.

Each of MLMs 215 and 225 may comprise one or more types of MLMs, such as: a K-nearest-neighbor regression model, a decision tree regression model, a random forest regression model, an XGBoost regression model, a deep neural network regression model, a long short-term memory (LSTM) model, a reinforcement learning model, and so forth. In this regard, it should be noted that as referred to herein, a machine learning model (MLM) (or machine learning-based model) may comprise a machine learning algorithm (MLA) that has been “trained” or configured in accordance with input training data to perform a particular service. For instance, a MLM may comprise a deep learning neural network, or deep neural network (DNN), a convolutional neural network (CNN), a recurrent neural network (RNN), a long-short term memory (LSTM) model, a transformer network, an encoder-decoder neural network, an encoder neural network, a decoder neural network, a variational autoencoder, a generative adversarial network (GAN), a decision tree algorithm/model, such as gradient boosted decision tree (GBDT) (e.g., XGBoost, XGBR, or the like), and so forth. In one example, one or more MLMs of the present disclosure may include supervised learning and/or reinforcement learning (e.g., using positive and negative examples after deployment as a MLM), and so forth. In one example, MLAs/MLMs of the present disclosure may be in accordance with an open source library, such as OpenCV, which may be further enhanced with domain-specific training data.

It should also be noted that FIG. 2 illustrates just one example of an IRG-UL platform 200 and that other, further, and different examples may include different components and/or may comprise a different architecture. For instance, in another example, MLMs may be independently developed for multiple outputs of the module 210. For example, one MLM can be trained to predict the latitude and one MLM can be trained to predict the longitude. Note that in the case of 5G systems with more advanced capabilities for beamforming and multi-layer data transmission, additional information such as beam indexes, beam angles, and rank indicator can also be used as input features to improve the performance of the system. Without loss of generality, other features, such as NCI, channel quality Indicator (CQI), physical uplink shared channel (PUSCH) signal-to-interference-and-noise ratio (SINR), power headroom, per-carrier transmit power, along with any other network performance indicators can also be used to improve the performance of the MLMs for location prediction and/or for network performance indicator value prediction. In addition, in one example, the components of the IRG-UL platform 200 may be implemented as a combination of a set of different non-real-time RAN intelligent controller (RIC) applications (e.g., rApps) and near-real-time RIC applications (e.g., xApps) in the 3GPP and ORAN RIC architecture. In one example, various MLMs can be trained/developed on-premises or in the cloud, and then instantiated/developed as rApps in ORAN architecture.

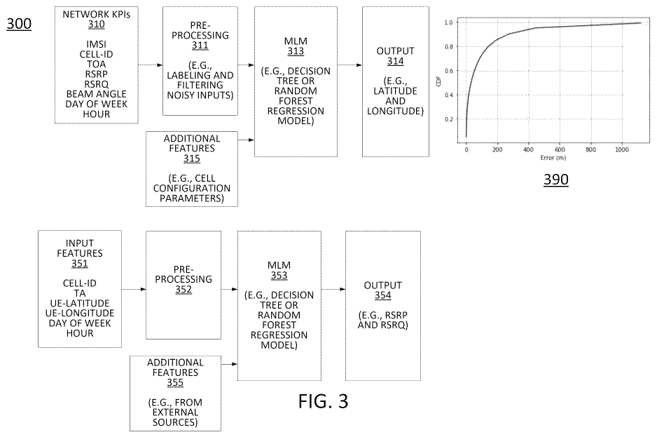

FIG. 3 illustrates a system 300 for implementing a pair of MLMs, e.g., in a LGE, where the goal of MLM 313 is to estimate the latitude and longitude of an endpoint device (based on a set of inputs) and the goal of MLM 353 is to estimate/predict the RSRP and RSRQ, based on a set of inputs. For instance, the inputs for MLM 313 may be network performance indicators (e.g., KPIs) 310, which may include IMSI, cell ID, TOA, RSRP, RSRQ, and beam angle. In other examples, different combinations of one or more network performance indicators may be used as inputs for the MLM 313. It should also be noted that in the present example, the inputs/input vector may further include day of the week and hour of the day. In other examples, a different granularity of time may be used, such as a particular x-interval (e.g., 10 minute interval) within the day, etc. In one example, an input vector to the MLM 313 may also include additional features 315, such as cell configuration parameters. In one example, the MLM 313 may be a regression model, such as a decision tree or random forest regression model. In other examples, the MLM 313 may be another type of MLM, e.g., as described above in connection with the MLM 215 of FIG. 2. The output 314 of the MLM 313 may be a location, e.g., in the form of latitude and longitude.

The input features 351 for the second MLM 353 may be cell ID, TA, and endpoint device location (e.g., UE latitude and UE longitude). In other examples, different combinations of one or more factors may be used as inputs for the MLM 353. In the present example, the inputs/input vector for MLM 353 may also include the day of the week and hour of the day. In other examples, a different granularity of time may be used, such as a particular 10 minute interval within the day, etc. In one example, an input vector to the MLM 353 may also include additional features 355, e.g., from external data sources, such as weather data, etc. In one example, the MLM 353 may be a regression model, such as a decision tree or random forest regression model. In other examples, the MLM 353 may be another type of MLM, e.g., as described above in connection with the MLM 225 of FIG. 2. The output 354 of the MLM 353 may be predicted network performance indicators of RSRP and RSRQ. In one example, the system 300 may include pre-processing operators 311 for the input data for MLM 313 and similarly pre-processing operators 352 for the inputs/input vector for MLM 353. These pre-processing operators 311 and 352 may be the same or similar to the pre-processing 218 and 228 of FIG. 2. FIG. 3 further illustrates a graph 390 showing the cumulative distribution function (CDF) performance of a realization of the MLM 313 for different values of distance error. It should also be noted that the MLM 353 may further demonstrate accurate performance in predicting the RSRP and RSRQ.

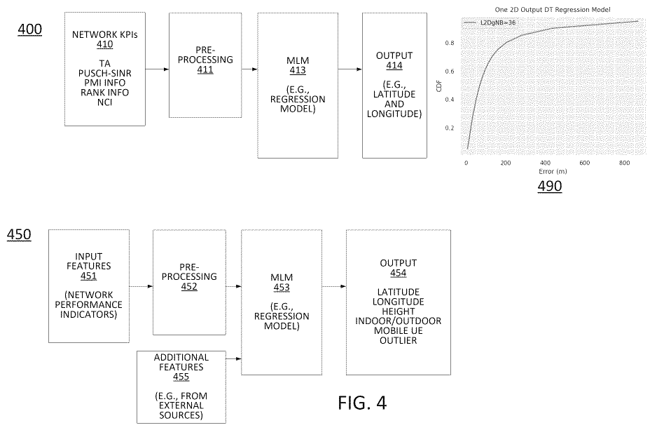

FIG. 4 illustrates an additional example system 400 for implementing a MLM 413 for endpoint device location prediction, where the inputs (e.g., network KPIs 410) include a combination of down-link and up-link performance indicators (e.g., timing advance (TA), physical uplink shared channel (PUSCH) signal-to-interference-and-noise ratio (SINR), precoding matrix indicator (PMI), rank information, and new radio cell identity (NCI). In one example, the present system 400 may further include a pre-processing operator 411 to apply one or more pre-processing techniques such as described above. Similar to the foregoing, the MLM 413 may comprise a regression model or other MLM. The output 414 may comprise a predicted endpoint device location, e.g., expressed as a latitude and longitude pair. Graph 490 shows the CDF performance of a realization of MLM 413/system 400 for different values of distance error. For instance, in one example, MLM 413 may be developed for a cluster of data from gNBs (where the last two digits of each gNB=36).

FIG. 4 illustrates another example system 450 for implementing a MLM 453 for endpoint device location prediction. In this case, the input features 451 may be the same or similar to any of the preceding examples. Likewise the additional features 455 and the pre-processing operator 452 may be the same or similar to any of the preceding examples. However, in this case, the MLM 453 may be trained to generate one or more additional indicators as output(s). For instance, in addition to latitude and longitude, output 454 may include altitude/height/elevation and/or a status of an endpoint device (e.g., indoor versus outdoor, mobile versus stationary). In one example output 454 may alternatively or additionally include an indicator of whether any one or more of the preceding indicators comprises an outlier (and hence may be an unreliable estimate/prediction).

In the present example, for training of MLM 453, each training input may have an additional field which indicates the status of an endpoint device (e.g., an indoor/outdoor indicator and/or a mobile/stationary indicator, etc.). Accordingly, in the prediction phase, MLM 453 may also estimate/predict the status of the endpoint device. This may be important for various applications, such as for tracking endpoint devices of first responders or individuals who may need assistance. In one example, the present disclosure may include an outlier indicator in the output 454, which shows if the estimated/predicted location is inside a feasible coverage of a cell or not. For instance, in a training phase, a feasible coverage area may be defined for a cell (e.g., based on the cell site location, the cell's coverage-range, tilt, azimuth bearing, boresight direction, etc.). For any training record, if an endpoint device is not inside the feasible region, it may be tagged as an outlier. Accordingly, in the prediction phase, outliers can be identified and filtered out to improve the accuracy and reliability of the system.

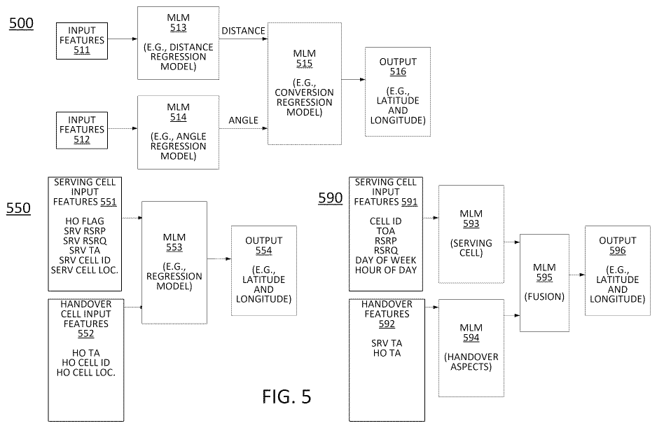

FIG. 5 illustrate an additional example system 500 for predicting endpoint device location that includes a multi-layer architecture (e.g., including a plurality of MLMs). In this architecture, input data may first be transformed, e.g., into a polar coordinate system, where respective MLMs 513 and 514 may be trained to estimate/predict the distance (\hat{d}) and Angle-of-Arrival (AOA denoted by θ), respectively, of an endpoint device with respect to a serving cell site. The MLM 515 may then be trained to use the predicted distance and AOA to estimate/predict the location of an endpoint device in latitude and longitude. MLMs 513 and 514 may have respective sets of input features 511 and 512, where the sets of input features 511 and 512 may or may not overlap. Note that by transforming data into a polar coordinate system, the adaptability and robustness of the framework may be increased with respect to changes in the network. For instance, system 500 may be extended to use network performance indicators and cell configuration parameters (e.g., cell location, antenna azimuth and tilt, transmit power, etc.), to predict a distance and angle of arrival of an endpoint device with respect to the cell site/location, which can then be mapped to any global coordinate system such as latitude and longitude. Accordingly, the system 500 can predict the location of an endpoint device in a newly deployed cell, where the system 500 (e.g., the MLMs 513-515 thereof) may have been trained on data from one or more other cells.

FIG. 5 further illustrate an additional example system 550 for implementing a MLM 553 for endpoint device location prediction/estimation, where Information from neighbor cells can also can be used. For instance, MLM 553 may be trained to ingest serving cell input features 551, such as serving cell (SRV) RSRP, RSRQ, TA, cell ID, and cell location (e.g., latitude and longitude). The additional field/input features “HO flag” may indicate whether features from a neighboring cell (e.g., a handover cell) may be used, e.g., handover cell input features 552, which include for the handover cell (HO): a TA, cell ID, and cell location. The output 554 may be an estimated/predicted location of an endpoint device, e.g., expressed in latitude and longitude, in one example.

In still another example, FIG. 5 illustrates and example system 590 for endpoint device location prediction/estimation that uses neighboring cell performance and/or configuration data in a multi-layer/multi-stage architecture. In particular, the system 590 may include a first MLM 593 that is trained/configured to predict and endpoint device location based upon serving cell input features 591 (e.g., cell ID, TOA, RSRP, RSRQ, day of week, and hour of day). System 590 may further include a second MLM 594 that is trained/configured to predict an endpoint device location based upon a set of handover features 592. In this case, the handover features 592 may relate to both the serving cell and the handover cell. For instance, handover features 592 may include TA of the serving cell and TA of the neighboring/handover cell, etc. The third MLM 595 may generate an output 596 comprising an estimated/predicted endpoint device location that is based upon the outputs of MLMs 593 and 594. In particular, MLMs 593 and 594 may generate respective endpoint device location predictions/estimations, which may be combined via MLM 595 to generate the output 596. For example, the MLMs 593-595 may be jointly or independently trained to minimize an error of location estimation. For instance, the training may involve a training data set with labeled instances of serving cell input features and handover features, e.g., labeled with known endpoint device location information, such as from endpoint devices that voluntarily report GPS-determined location information with MDT measurements/reports. It should be noted that in one or several examples, information from neighboring cells (e.g., RSRP/RSRQ and SINR) may be used as input features that are relevant to computing the distance of a neighbor cell site from a serving cells and a bearing/angle of a neighbor cell site from the serving cell site. For instance, using such information as additional inputs for either or both of the MLMs 593 and 594 may improve the accuracy of the system 590.

A long list of additional inputs/input features can be used when developing the above-described MLMs, including but not limited to: weather information, path-loss information/parameters, sensory information (e.g., velocity, acceleration, barometric pressure, etc.), endpoint device Identifiers (e.g., IMSI, IMEI, telephone number(s), etc.), and so forth. In addition, appropriate transformations may be applied, such as label encoding, selecting a sufficient/appropriate number of training records per cell, number of training records per endpoint device, and/or number of training records per cell/endpoint device pairing, and so on. Time information (e.g., hour, day of the week, etc.), type of the device (e.g., manufacturer 1, manufacturer 2, etc. and/or device model type), endpoint device age, cell age, cell location information (e.g., market, city, zip-code, etc.), and/or other features may all be used to supplement the inputs of the foregoing MLMs. Furthermore, using such additional information can improve the performance of the system for newly deployed cells and newly added devices/UEs. Note that, some network performance indicator measurements/records can also be adjusted during the training/prediction phase based on endpoint device model/type and cell configuration parameters (e.g., vendor information, etc.). For example, if data of type-1 devices have been used for training, when a MLM may be tasked with estimating the location of an endpoint device of type-2, some network performance indicator data may be adjusted before being applied to the model. To illustrate, in one example, a RSRP measurement of a type-2 device may be uniformly shifted by X dBm where X has been computed based on historical data analysis). Such adjustments can be more fine-grained and can be applied based on the timing advance (TA), pre-coding matrix information (PMI), and beam information. Another input may be a cluster index for cells and endpoint device. For instance, in this case, cells and/or endpoint devices may be clustered into a limited number of clusters, where the index of a cluster can be used as another input feature to one or more MLMs. This may provide improved accuracy as well as expedited convergence of the MLM(s) during the model training process.

It should be noted that in one example, the output of an MLM of the present disclosure for endpoint device location prediction/estimation may include additional target variables, such as sensory information. For example, the barometric pressure may be predicted as an additional MLM output, which may be used an approximate indicator of the height and/or elevation of the endpoint device and/or which may be used as a proxy for an indoor/outdoor indicator (particularly if correlated with temperature information). Similarly, additional outputs may also include endpoint device velocity and/or acceleration to differentiate between a mobile endpoint device and a stationary endpoint device.

More sophisticated post-processing can be applied to improve the accuracy of location estimates and predicted network performance indicator values. For example, home/business locations can be used to cluster data and map estimates to the customer locations. Alternatively, or in addition, road map information can be used to map endpoint devices location estimates onto such roads for mobile/in-motion endpoint devices. More advanced post processing, such as using different versions of Kalman filters, spatial-temporal collaborative filtering (with or without constraints), and deep-learning techniques (e.g., LSTM and 1D-CNNs) may also be used to improve the performance of examples of the present disclosure.

To reduce the noise during the training, training data can be clustered for small regions (e.g., small circles with a radius of x-meters), where a center of a circle can be used as a target location for a given cluster (e.g., for all records in that cluster). Accordingly, classification MLMs may be used, e.g., as an alternative or in addition to regression-based MLMs. To further illustrate, in one example, a 1D-CNN classifier may be used to estimate the location of an endpoint device. A similar configuration may also be used for developing a complementary MLM for network performance indicator value estimation/prediction.

To improve the efficiency and accuracy of the MLM(s) during the training and prediction phases, different sampling techniques can be used. For example, all training records from cells with low amount of training data may be selected, while a lesser percentage of data from cells with large number of training records may be selected. In another example, data can be clustered in small regions, where a portion of the records from each cluster may be sampled. Each cluster can be defined by rounding the endpoint device latitude and endpoint device longitude to a specified number of decimal digits (e.g., 3 or 4 decimal digits), where records with a same pair of (rounded latitude, rounded longitude) values can be grouped to construct a cluster.

In one example, noisy records can be removed during either or both of the training and inference/prediction phases. In various examples, noisy records may be identified using different criteria. For example, records with RSRP, RSRQ, SINR, or PUSCH-SINR lower than some threshold(s) can be removed, e.g., where the threshold(s) can be predefined in advance, may be fixed or may be dynamic based on a percentage of some recently observed maximum, minimum, average, or the like with respect to one or more network performance indicators. Moreover, outlier records, e.g., with very large distances from the serving cell can be removed from training data. Likewise, during the inference phase, records with very large values of timing advance (TA), e.g., outside the feasible coverage area of the cell, can also be filtered out and/or tagged/flagged as being outliers.

In one example, the present disclosure may incorporate label encoding for one or more categorical variables such as cell ID(s) and/or endpoint device identifier(s). This may help reduce the size of the MLM(s), which is particularly useful in large-scale networks where numerous MLMs may be deployed (e.g., at least a pair of MLMs per cell, per cluster/neighborhood, per tracking area, or the like). A variety of label encoding methods may be used, such as random label encoding, smart label-encoding (e.g., where a set of consecutive positive integers may be assigned cells and/or endpoint devices that share some common features), and so forth. In one embodiment, a set of consecutive integers may be assigned to cells within a cluster using a same frequency band, where cells within a zip-code may sub-set of such consecutive integers.

In general, an IRG-UL platform of the present disclosure may estimate the location of an endpoint device in different global/relative coordinate systems. For example, an endpoint device location can be represented as a global latitude, longitude, and altitude (3D location information), or the endpoint device location can be represented as a relative distance, angle (e.g., bearing/angle), and/or height from a certain location on the planet (e.g., a cell location in a mobile network). Thus, these and other modifications are all contemplated within the scope of the present disclosure.

FIG. 6 illustrates a flowchart of an example method 600 for reconfiguring at least one aspect of a cellular network in response to at least one network performance indicator measurement that is tagged with a predicted location generated via a machine learning model in response to an input vector comprising the at least one network performance indicator measurement, in accordance with the present disclosure. In one example, steps, functions and/or operations of the method 600 may be performed by a device as illustrated in FIG. 1, e.g., SMO 190 and/or RIC 199, a NWDAF 192, or any one or more components thereof, such as a processing system, or collectively via a plurality devices in FIG. 1, such as SMO 190 in conjunction with NWDAF 192, cell sites 121-124, BBU pool 126, and so forth. In one example, the steps, functions, or operations of method 600 may be performed by a computing device or system 700, and/or a processing system 702 as described in connection with FIG. 7 below. For instance, the computing device 700 may represent at least a portion of SMO 190, RIC 199, and/or NWDAF 192 in accordance with the present disclosure. For illustrative purposes, the method 600 is described in greater detail below in connection with an example performed by a processing system, such as processing system 702. The method 600 begins in step 605 and proceeds to step 610.

At step 610, the processing system obtains at least one network performance indicator measurement associated with an endpoint device in a cellular network. For instance, the at least one network performance indicator measurement may include at least one of: a downlink signal quality metric, an uplink signal quality metric, a RSRP, a RSRQ, a TOA, a beam angle (e.g., where beam angle may include angle of arrival (AoA)), a communication link performance indicator, a network resource utilization performance indicator, an endpoint device resource utilization performance indicator, and so forth. Without loss of generality, other features, such as a NCI, CQI, PUSCH-SINR, power headroom, per-carrier-transmit power, along with any other network KPIs can also be used in various examples.

At step 620, the processing system applies an input vector including the at least one network performance indicator measurement to a machine learning model (MLM) implemented by the processing system that is configured to generate an output comprising a predicted location of the endpoint device. In one example, the input vector may further include at least one cell configuration parameter setting. Accordingly, in such an example, the MLM may be trained/configured to generate an output comprising the predicted location of the endpoint device in response to the input vector comprising the at least one network performance indicator measurement and the at least one cell configuration parameter setting. To further illustrate, cell configuration parameters may include: technology (LTE or 5G), frequency band, operating frequency, antenna tilt, antenna azimuth, transmit power, number of antennas, cell latitude, cell longitude, antenna propagation model/type, clutter type, environment type, and part of the digits of eNB-ID or gNB-ID, or the like. In one example, the input vector may further include data from one or more data sources external to the cellular network. For instance, such data may include weather information, demographic information, geographic map information, or the like.

In one example, the MLM may comprise a regression model, such as a decision tree or a random forest regression model. In another example, the MLM may be of a different type, such as a CNN, a 1D-CNN, etc. In one example, the MLM may be trained using training data from a cluster of cells (e.g., geographic clustering). Alternatively, or in addition, the MLM may be trained using training data associated with one or more defining parameters, where the processing system may implement a plurality of MLMs that are configured to generate predicted locations of endpoint devices in response to input vectors comprising network performance indicator measurements associated with the respective endpoint devices, and where each of the plurality of MLMs is trained using respective training data associated with different sets of defining parameters. For instance, the processing system may implement data clustering, where each MLM may be specific to data having one or more shared characteristics (e.g., a first model for device type A, a second model for device type B, etc.). In one example, the processing system may implement MLMs that are associated with both geographic clustering and data clustering. In addition, it should be noted that the type of MLM, the input features, and/or the output features of the MLM for each cluster may be different. In various example, the predicted location may include: (a) a latitude and a longitude, or (b) a distance and bearing (angle) from a reference location (e.g., where the reference location may be a serving cell location or other location). In one example, the predicted location may further include an altitude, elevation, and/or height of the endpoint device. Alternatively, or in addition, the predicted location (e.g., the MLM output), may further include a mobility status of the endpoint device and/or an indoor-versus-outdoor status of the endpoint device.

At step 630, the processing system tags the at least one network performance indicator measurement with the predicted location. For instance, the processing system may store time-stamped network performance indicator records, where the records may include location information associated with the network performance indicator measurements, and where the location information may be obtained directly form endpoint devices (e.g., self-reported based on GPS measurements, or the like) or estimated/predicted in accordance with step 620 of the present method 600. The storing may be the processing system itself, or may include the processing system storing the record in a data storage system, such as associated with a NWDAF, a UDM and/or HSS, or the like, a cloud data storage system, and so forth.

At step 640, the processing system reconfigures at least one aspect of the cellular network in response to the at least one network performance indicator measurement that is tagged with the predicted location. For instance, as noted above the processing system may comprise a service and management orchestrator (SMO), a SON orchestrator, an SDN controller, and or a RAN intelligent controller (RIC) that is capable of configuring/reconfiguring various components of the cellular network. In one example, the reconfiguring may be triggered individually by the at least one network performance indicator measurement that is tagged with the predicted location or collectively with respect to a plurality of network performance indicator measurements tagged with location information for the same endpoint device or a plurality of endpoint devices including the endpoint device with respect to a sector, a cell site, a tracking area, etc. For example, the reconfiguring, or adjusting of the at least one aspect of the cellular network may include: activating a remote radio head, activating a baseband unit, deactivating a remote radio head, deactivating a baseband unit, changing a transmit power of a base station, changing a boresight direction of an antenna array and/or a receive or transmit beam (including adjusting tilt and azimuth bearing), changing a beamwidth of a gain pattern of an antenna array, changing a channel coding scheme availability at a base station, changing a base station backhaul configuration, activating a network slice, allocating additional resources to a network slice, and so forth. I

In one example, the adjusting may be more specific to the particular endpoint device, such as initiating a handover from one serving cell to another, allocating additional bearers, changing access technology (e.g., uplift to 5G, fallback to 4G/LTE, or the like, Wi-Fi offloading, etc.), and so forth. In one example, the reconfiguring may relate to all or a portion of the same cell configuration parameters that may be used as additional inputs to the MLM, such as: technology used (LTE or 5G), frequency band, operating frequency, antenna tilt, antenna azimuth, transmit power, and so forth. For instance, step 640 may include changing of an access technology serving the endpoint device, changing of an antenna beam direction, changing of an antenna beam width, changing an antenna radiation pattern, changing of an antenna transmit power, changing of an antenna port, changing of a communication frequency associated with the endpoint device, or the like. In various example, any network configuration selection/reconfiguration that is dependent upon location-specific network performance indicators may be adjusted at step 640 in response to the at least one network performance indicator measurement that is tagged with the predicted location (e.g., either individually or collectively with respect to other measurements and/or predicted network performance indicator values associated with the same endpoint device or a plurality of endpoint devices including the endpoint device).

At optional step 650, the processing system may apply a second input vector comprising the predicted location to a second MLM implemented by the processing system that is configured to generate an output comprising at least one predicted network performance indicator value associated with the endpoint device in response to the second input vector. In one example, the second input vector may further include a cell identifier and/or a timing advance (TA) value (e.g., the value representing a measure of delay between an endpoint device and a base station). In one example, the second MLM can also use other network performance indicators/network performance indicator values and/or cell configuration parameter setting(s) as additional inputs to predict the at least one network performance indicator value. In one example, the second MLM may comprise a regression model, such as a decision tree or a random forest regression model. In another example, the MLM may be of a different type, such as a CNN, a 1D-CNN, etc.

At optional step 660, the processing system may calculate an accuracy metric based upon a difference between the at least one predicted network performance indicator value and the at least one network performance indicator measurement. For instance, the accuracy metric may comprise the difference, a scaled or weighted distance, etc. In the case where the output of the second MLM comprises a set of multiple predicted network performance indicator values, the accuracy metric may be based upon a difference between respective predicted network performance indicator values and network performance indicator measurements of the same respective types. For instance, the accuracy metric may comprise a weighted sum of the distances/differences between respective predicted values and the corresponding measurements.

At optional step 670, the processing system may retrain at least one of: the machine learning model or the second machine learning model in accordance with the accuracy metric of optional step 660. For instance, optional step 670 may include adjusting one or more hyperparameters and may be based on one or more of gradient descent, reinforcement learning, and so forth.

Following step 640 or any of optional steps 650-670, the method 600 may proceed to step 695 where the method 600 ends.

It should be noted that the method 600 may be expanded to include additional steps or may be modified to include additional operations with respect to the steps outlined above. In one example, various steps of the method 600 may be repeated for the same or different endpoint device, for the same or different portion of the cellular network, and so forth. For example, the method 600 may be repeated as the endpoint device moves throughout an environment and the endpoint device's physical location and associated network performance indicator measurements may change. In one example, the method 600 may be expanded to further include training of the first MLM and/or the second MLM, e.g., individually and/or jointly, such as via a joint objective function/optimization criterion. For instance, this may be to increase the accuracy and/or minimize the distance associated with the accuracy metric of optional step 660. In such an example, the method 600 may further include obtaining location-tagged training records, such as MDT measurements/reports where endpoint devices have voluntarily included detailed location information (e.g., from GPS measurements). In one example, the method 600 may further include one or more pre-processing and/or post-processing techniques. For instance, the method 600 may include removing outliers from a training data set. Alternatively, or in addition, step 630 may include tagging a predicted location as an outlier. Likewise, step 650 may be followed by tagging of the at least one predicted network performance indicator value as an outlier (e.g., if/when outside of an acceptable/plausible range of values).

In one example, step 650 may be followed by storing of a record including the at least one predicted network performance indicator value. For instance, where a network may have sparse records of actual measurements, the network performance indicator values may be synthetically generated via the second MLM and stored for use in connection with other applications/services (e.g., other xApps or rApps may access and use such data). In this regard, it should be noted that in one example, at least one of the machine learning model or the second machine learning model may be trained using synthetic generated data from a different one of the machine learning model or the second machine learning model. Alternatively, or in addition, in one example, at least one of the first MLM or the second MLM may be trained using a sampled set of training data, where the sampled set of training data is sampled from a larger data set using one or more sampling techniques. In one example, the method 600 may be expanded or modified to include steps, functions, and/or operations, or other features described above in connection with the example(s) of FIGS. 1-5, or as described elsewhere herein. Thus, these and other modifications are all contemplated within the scope of the present disclosure.

In addition, although not specifically specified, one or more steps, functions, or operations of the example, method 600 may include a storing, displaying, and/or outputting step as required for a particular application. In other words, any data, records, fields, and/or intermediate results discussed in the method can be stored, displayed, and/or outputted either on the device executing the method or to another device, as required for a particular application. Furthermore, steps, blocks, functions or operations in FIG. 6 that recite a determining operation or involve a decision do not necessarily require that both branches of the determining operation be practiced. In other words, one of the branches of the determining operation can be deemed as an optional step. Furthermore, steps, blocks, functions or operations of the above described method(s) can be combined, separated, and/or performed in a different order from that described above, without departing from the examples of the present disclosure.

FIG. 7 depicts a high-level block diagram of a computing device or processing system specifically programmed to perform the functions described herein. As depicted in FIG. 7, the processing system 700 comprises one or more hardware processor elements 702 (e.g., a central processing unit (CPU), a microprocessor, or a multi-core processor), a memory 704 (e.g., random access memory (RAM) and/or read only memory (ROM)), a module 705 for reconfiguring at least one aspect of a cellular network in response to at least one network performance indicator measurement that is tagged with a predicted location generated via a machine learning model in response to an input vector comprising the at least one network performance indicator measurement, and various input/output devices 706 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). In accordance with the present disclosure input/output devices 706 may also include antenna elements, antenna arrays, remote radio heads (RRHs), baseband units (BBUs), transceivers, power units, and so forth. Although only one processor element is shown, it should be noted that the computing device may employ a plurality of processor elements. Furthermore, although only one computing device is shown in the figure, if the method(s) as discussed above is/are implemented in a distributed or parallel manner for a particular illustrative example, i.e., the steps of the above method(s) is/are implemented across multiple or parallel computing devices, e.g., a processing system, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented. The hardware processor 702 can also be configured or programmed to cause other devices to perform one or more operations as discussed above. In other words, the hardware processor 702 may serve the function of a central controller directing other devices to perform the one or more operations as discussed above.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed method(s). In one example, instructions and data for the present module or process 705 for reconfiguring at least one aspect of a cellular network in response to at least one network performance indicator measurement that is tagged with a predicted location generated via a machine learning model in response to an input vector comprising the at least one network performance indicator measurement (e.g., a software program comprising computer-executable instructions) can be loaded into memory 704 and executed by hardware processor element 702 to implement the steps, functions, or operations as discussed above in connection with the illustrative method(s). Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 705 for reconfiguring at least one aspect of a cellular network in response to at least one network performance indicator measurement that is tagged with a predicted location generated via a machine learning model in response to an input vector comprising the at least one network performance indicator measurement (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette, and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of illustration only, and not a limitation. Thus, the breadth and scope of any aspect of the present disclosure should not be limited by any of the above-described examples, but should be defined only in accordance with the following claims and their equivalents.

What is claimed is:

1. A method comprising:
obtaining, by a processing system including at least one processor, at least one network performance indicator measurement associated with an endpoint device in a cellular network;
applying, by the processing system, an input vector including the at least one network performance indicator measurement to a machine learning model implemented by the processing system that is configured to generate an output comprising a predicted location of the endpoint device;
tagging, by the processing system, the at least one network performance indicator measurement with the predicted location; and
reconfiguring at least one aspect of the cellular network in response to the at least one network performance indicator measurement that is tagged with the predicted location.

2. The method of claim 1, further comprising:
applying a second input vector comprising the predicted location to a second machine learning model implemented by the processing system that is configured to generate an output comprising at least one predicted network performance indicator value associated with the endpoint device in response to the second input vector.

3. The method of claim 2, further comprising:
calculating an accuracy metric based upon a difference between the at least one predicted network performance indicator value and the at least one network performance indicator measurement.

4. The method of claim 3, further comprising:
retraining at least one of: the machine learning model or the second machine learning model in accordance with the accuracy metric.

5. The method of claim 2, wherein the second input vector further includes at least one of:
a cell identifier; or
a timing advance value.

6. The method of claim 2, wherein each of the machine learning model and the second machine learning model comprises:
a decision tree;
a random forest regression model;
a k-nearest-neighbor regression model;
a gradient boosted decision tree regression model;
a deep neural network regression model;
a long short-term memory model; or
a reinforcement learning model.

7. The method of claim 2, wherein at least one of the machine learning model or the second machine learning model is trained using synthetic generated data from a different one of the machine learning model or the second machine learning model.

8. The method of claim 2, wherein at least one of the machine learning model or the second machine learning model is trained using a sampled set of training data, wherein the sampled set of training data is sampled from a larger data set using one or more sampling techniques.

9. The method of claim 1, wherein the machine learning model is trained using training data from a cluster of cells.

10. The method of claim 1, wherein the machine learning model is trained using training data associated with one or more defining parameters, wherein the processing system implements a plurality of machine learning models that are configured to generate predicted locations of endpoint devices in response to input vectors comprising network performance indicator measurements associated with the endpoint devices, and wherein each of the plurality of machine learning models is trained using respective training data associated with different sets of defining parameters.

11. The method of claim 1, wherein the at least one network performance indicator measurement comprises at least one of:
a downlink signal quality metric;
an uplink signal quality metric;
a reference signal received power;
a reference signal received quality;
a time of arrival;
a beam angle;
a communication link performance indicator;
a network resource utilization performance indicator; or
an endpoint device resource utilization performance indicator.

12. The method of claim 1, wherein the input vector further includes at least one cell configuration parameter setting, wherein the machine learning model is configured to generate the output comprising the predicted location of the endpoint device in response to the input vector comprising the at least one network performance indicator measurement and the at least one cell configuration parameter setting.

13. The method of claim 1, wherein the input vector further includes data from one or more data sources external to the cellular network, wherein the data from the one or more data sources external to the cellular network includes at least one of:
weather information;
demographic information; or
geographic map information.

14. The method of claim 1, wherein the predicted location comprises:
a latitude and a longitude; or
a distance and bearing from a reference location.

15. The method of claim 14, wherein the predicted location further comprises:
an elevation;
an altitude; or
a height.

16. The method of claim 14, wherein the predicted location further includes at least one of:
a mobility status; or
an indoor-versus-outdoor status.

17. The method of claim 1, wherein the reconfiguring comprises at least one of:
changing of an access technology serving the endpoint device;
changing of an antenna beam direction;
changing of an antenna beam width;
changing of an antenna radiation pattern;
changing of an antenna transmit power;
changing of an antenna port; or
changing of a communication frequency associated with the endpoint device.

18. The method of claim 1, wherein the processing system comprises a radio access network intelligent controller.

19. A non-transitory computer-readable medium storing instructions which, when executed by a processing system including at least one processor, cause the processing system to perform operations, the operations comprising:
obtaining at least one network performance indicator measurement associated with an endpoint device in a cellular network;
applying an input vector including the at least one network performance indicator measurement to a machine learning model implemented by the processing system that is configured to generate an output comprising a predicted location of the endpoint device;
tagging the at least one network performance indicator measurement with the predicted location; and
reconfiguring at least one aspect of the cellular network in response to the at least one network performance indicator measurement that is tagged with the predicted location.

20. An apparatus comprising:
a processing system including at least one processor; and
a computer-readable medium storing instructions which, when executed by the processing system, cause the processing system to perform operations, the operations comprising:
obtaining at least one network performance indicator measurement associated with an endpoint device in a cellular network;
applying an input vector including the at least one network performance indicator measurement to a machine learning model implemented by the processing system that is configured to generate an output comprising a predicted location of the endpoint device;
tagging the at least one network performance indicator measurement with the predicted location; and
reconfiguring at least one aspect of the cellular network in response to the at least one network performance indicator measurement that is tagged with the predicted location.
